(19) United States
(12) Patent Application Publication
(10) Pub. No.: US 2006/0035782 A1
(43) Pub. Date: Feb. 16, 2006

(54) PROCESSING METHODS AND FORMULATIONS TO ENHANCE STABILITY OF LEAN-NOx-TRAP CATALYSTS BASED ON ALKALI- AND ALKALINE-EARTH-METAL COMPOUNDS

(75) Inventors: Hungwen Jen, Troy, MI (US); George Graham, Ann Arbor, MI (US); Robert McCabe, Lathrup Village, MI (US)

Correspondence Address: BROOKS KUSHMAN P.C./FGTL, 1000 TOWN CENTER, 22ND FLOOR, SOUTHFIELD, MI, 48075-1238, US

(73) Assignee: Ford Global Technologies, LLC, Dearborn, MI (US)

(21) Appl. No.: 10/710,920

(22) Filed: Aug. 12, 2004

(51) Int. Cl. B01J 23/10; B01J 31/00

(52) U.S. Cl. 502/300; 502/304; 502/341; 502/103

(57) ABSTRACT

The present invention provides a coarsening resistant automotive exhaust catalyst composition. The composition of the invention comprises a metal or metal-containing compound and a component having alkali metal or an alkaline-earth metal ions bonded to a conjugate base oxide of an inorganic acid. The inorganic acid for which the base oxide is conjugate has a Ka such that the automotive exhaust catalyst composition resists phase transitions that reduce surface area. The present invention also provides a NOx trap which incorporates the exhaust catalyst composition of the invention. Finally, a method of inhibiting coarsening in automotive exhaust catalyst is also provided.

### BACKGROUND OF INVENTION

1. Field of the Invention

The present invention is related to methods and formulations that provide automobile exhaust catalysts with resistance to coarsening.

2. Background Art

Environmental concerns and governmental regulations have been a continuing impetus for improvements in pollution control from automotive vehicles. The treatment or removal of noxious combustion by-products from the exhaust of such vehicles is a major focus of such efforts. Typically these combustion by-products include incomplete combustion by-products such as carbon monoxide and hydrocarbons. Moreover, the exhaust of these vehicles also includes various nitrogen oxides and sulfur oxides. It is desirable and mandated that certain of these compounds be reduced during vehicle operation.

Currently, the exhaust systems of automotive vehicles include one or more catalysts to effect the control of such by-products. Compounds of basic (alkali or alkaline-earth) metals such as barium have been used in automotive catalysts to store NOx under oxygen-rich conditions during the lean operation of internal combustion engines. In particular, lean-NOx-traps (“LNT”) utilize catalysts that contain large amounts of such basic-metal compounds to remove NOx from the exhaust of lean-burn engines. These LNT catalysts may be used in both gasoline and diesel engines. In addition to barium (or other basic-metal) compounds, typical LNT catalysts also include a precious metal (“PM”) such as platinum. The PM is believed to be involved in the oxidation of NO, first to NO₂, and then to a nitrate (i.e., barium nitrate). The nitrate is subsequently reduced to N₂ under oxygen-deficient conditions during rich operation of the engines. Since the basic-metal compounds are involved in absorption of NOx and are required to be associated with PM for oxidation and reduction processes, it is very desirable to ensure that a large portion of these compounds are accessible to gaseous exhaust components and be in close contact with the PM. LNTs are typically fabricated by first impregnating alumina with alkali or alkaline-earth metals and precious metals, and then depositing this material on a honeycomb substrate. Although current LNT technology works reasonably well, it is observed that the performance of such traps degrades over time. One reason for this degradation is the loss of surface area of the NOx absorbing component. It is believed that this loss in surface area results from the gradual formation of grains or particles of the NOx absorbing component that are significantly larger than the grains or particles that are present when the composition is newly formed. This process is generally referred to as coarsening.

In addition to LNTs, three-way catalysts (“TWC”) are also deployed in automobile exhaust systems to remove carbon monoxide, hydrocarbons, and nitrogen oxides. As in the LNT, the typical TWC is a monolithic structure, based on a honeycomb substrate with numerous small channels that are coated with a material containing the catalyst. This material, called the washcoat, usually consists of a mixture of oxides (e.g., γ-Al₂O₃) and precious metals. The mixture of oxides used may also include base-metal oxides. For example, in addition to aluminum, cerium and zirconium oxides, small amounts of calcium and magnesium oxides, as well as rare-earth elements such as La₂O₃ have been used as promoters or stablilizers. Such TWC compositions may also be susceptible to coarsening during aging.

Accordingly, there is a need in the prior art for methods of reducing the tendency for automotive exhaust catalysts to coarsen upon aging.

### SUMMARY OF INVENTION

In an embodiment of the present invention, a coarsening resistant automotive exhaust catalyst composition (i.e., the composition resists forming grains or particles that are significantly larger than the grains or particles that are present when the composition is newly formed) is provided. The composition of the invention comprises a metal or metal-containing compound and an alkali or alkaline-earth metal conjugate base oxide of an inorganic acid. The inorganic acid for which the base oxide is conjugate has a Ka such that the automotive exhaust catalyst composition resists phase transitions that reduce surface area.

In another embodiment of the invention a NOx trap that uses the automobile exhaust catalyst composition of the invention is provided. The NOx trap of the invention includes a substrate and a catalyst composition coated upon the substrate. The catalyst composition of this embodiment is the same as the automobile exhaust catalyst composition set forth above. Accordingly, the catalyst composition comprises a metal or metal-containing compound and an alkali or alkaline-earth metal conjugate base oxide of an inorganic acid. The inorganic acid for which the base oxide is conjugate has a Ka such that the automotive exhaust catalyst composition resists phase transitions that reduce surface area.

In yet another embodiment of the invention, a method of inhibiting coarsening in a catalyst composition that includes an alkali- or alkaline-earth-metal compound is provided. The method of the invention advantageously utilizes the compositions set forth above to form catalysts that resist coarsening. The method of the invention comprises combining a metal or metal-containing compound with the catalyst composition that includes an alkali or alkaline-earth metal conjugate base oxide of an inorganic acid. The inorganic acid for which the base oxide is conjugate has a Ka such that the automotive catalyst composition resists phase transitions that reduce surface area.

### BRIEF DESCRIPTION OF DRAWINGS

FIG. 1 provides XRD patterns for 2% Pt/(BaO-6Al₂O₃) after (a) aging at 800° C.; (b) exposure to ambient air for 6 months following (a); and (c) heating in hydrogen at 500° C. following (b);

FIG. 2 provides XRD patterns for ceria-doped barium hexaaluminate nanocomposite (a) after 750° C.-calcination; (b) wetted with water and dried after (a); (c) after 750° C.-calcination following (b); (d) after 850° C.-calcination following (c);

FIG. 3 provides XRD patterns for a commercial automotive catalyst containing barium after (a) aging at 954° C. in simulated exhausts; (b) exposure to water following (a); (c) exposure to 1N HNO₃ solution following (b).

FIG. 4 provides XRD patterns for samples of 5 wt % Ba loaded onto γ-Al₂O₃, with and without 1.6% P added, and 10 wt % Ba loaded onto γ-Al₂O₃, with and without 3.2% P added, after the samples were wetted with water and dried.

FIG. 5 provides XRD patterns for samples of 10 wt % Ba loaded onto SAPO-11 after the samples were calcined, wetted with water and dried, and then exposed to 1N HNO₃ solution.

### DETAILED DESCRIPTION

Reference will now be made in detail to presently preferred compositions or embodiments and methods of the invention, which constitute the best modes of practicing the invention presently known to the inventors.

In an embodiment of the present invention, a coarsening resistant automotive exhaust catalyst composition (i.e., the composition resists forming grains or particles that are significantly larger than the grain or particles that are present when the composition is newly formed) is provided. The composition of the invention comprises a metal or metal-containing compound and a component (i.e., a compound) having metal ions bonded to a conjugate base of an inorganic acid. The metal ions that are bonded to the conjugate base are selected from the group consisting of alkali metal ions, alkaline-earth metal ions, and combinations thereof. Moreover, the conjugate base of an inorganic acid is preferably a conjugate base oxide of an inorganic acid. As used herein, “conjugate base” means the ion formed when an acid loses one or more hydrogen ions (i.e., H+). As used herein, “conjugate base oxide” is a conjugate base that has one or more bonds between oxygen and another element. Typically, the metal or metal containing compound will alter the amount of a chemical component in the automobile exhaust (e.g., the NO, CO, SO₂, hydrocarbons, etc). The inorganic acid for which the base oxide is conjugate has a Ka such that the automotive exhaust catalyst composition resists phase transitions that reduce surface area. The method of the present invention is found to advantageously reduce the occurrence of such transitions that are present in automotive exhaust catalyst systems that do not contain such conjugate base oxides of inorganic acids. Such catalyst systems include for example, lean NOx catalyst systems, three-way catalyst systems, and sulfur trapping systems.

A particular example, illustrating the present invention, is detailed as follows. Relevant chemical reactions involving various barium (Ba) species are:
CO₂+H₂O->H₂CO₃— (1)
BaO+H₂CO₃->BaCO₃+H₂O— (2)
BaAl₂O₄+H₂CO₃->BaCO₃+H₂Al₂O₄— (3)
BaCO₃+H₂Al₂O₄->BaAl₂O₄+CO₂↑+H₂O↑ (4)

Upon exposure of water to CO₂ in air, carbonic acid forms as in (1). The Ba, which may be present in the typical Pt/BaO/Al₂O₃ LNT composition as BaO or BaAl₂O₄, readily reacts with H₂CO₃ to form BaCO₃ crystallites as in (2) and (3). The reaction is governed by acid-base chemistry. H₂CO₃ is more acidic than H₂O or H₂Al₂O₄, and basic Ba will react preferentially with H₂CO₃ over H₂O or H₂Al₂O₄. Reaction (4) shows the way in which BaCO₃ can be destroyed at high temperatures, especially when CO₂ or H₂O partial pressure is continuously decreased. However, subsequent exposure to H₂O and CO₂ at low temperature restarts reactions (1), (2), and (3), and BaCO₃ crystallites can reform again. As BaCO₃ crystallites reform, XRD patterns reveal larger particles of BaCO₃. This coarsening of Ba-containing particles decreases available Ba sites for NOx adsorption and lowers the contact between Ba and Pt. Since the cyclic formation of BaCO₃ and BaAl₂O₄ can lead to coarsening of Ba-containing particles, one solution is to prevent the formation of BaCO₃ as the LNT is exposed to engine exhaust, which always contains CO₂ and H₂O. The proposed means of achieving this solution is to bind Ba in an LNT to a conjugate base oxide of an acid that is more acidic than carbonic acid. Thus, the formation of BaCO₃ can be prevented. Two examples are BaSO₂ and Ba₃(PO₄)₂.

The application of Ba in an LNT is for NOx absorption. It has been shown that the adsorption product is most likely Ba(NO₃)₂. It is also reported that Ba(NO₃)₂ can form from BaCO₃. According to acid-base chemistry, reaction (5) below is favorable because HNO₃ is more acidic than H₂CO₃:
BaCO₃+2HNO₃->Ba(NO ₃)₂+H₂CO₃— (5)

Higher acidity of HNO₃ explains why NOx can be adsorbed on Ba sites even in engine exhaust with much higher CO₂ than NOx concentration. If Ba is bound to a conjugate base oxide of an acid with higher acidity than HNO₃, then adsorption of NOx will not proceed. An example is BaSO₄, derived from conjugate base oxide of H₂SO₄. Since H₂SO₄ is more acidic than HNO₃, the following reaction is not favorable:
BaSO₄+2HNO₃->Ba(NO₃)₂+H₂SO₄— (6)

Since Ba sites on BaSO₄ cannot be used for adsorption of NOx, sulfur is a serious poison to an LNT. Thus, the conjugate base oxide used to bind Ba in an LNT needs to be derived from an acid that is less acidic than HNO₃.

The automobile exhaust catalyst composition of the present invention includes a component having metal ions bonded to a conjugate base of an inorganic acid. The inorganic acid for which the base oxide is conjugate has a Ka such that the automotive exhaust catalyst composition resists phase transitions that reduce surface area. Typically, this inorganic acid has a Ka value from about 5.0×10⁻⁷ to about 1.0. In other variations, the inorganic acid for which the base oxide is conjugate has a Ka value from about 5.0×10⁻⁵ to about 1.0×10⁻¹. These criteria may be restated as requiring that the inorganic acid for which the base oxide is conjugate is more acidic than H₂CO₃ and less acidic than HNO₃. Moreover, the conjugate base oxide must be able to be well dispersed within the other components of the automobile exhaust catalyst composition. Yet another way of restating these criteria is that the formation energy of the alkali or alkaline-earth metal conjugate base oxide is greater than that of the corresponding carbonate but less than that of the corresponding nitrate. As set forth above, the metal ions that are bonded to the conjugate base include ions selected from the group consisting of alkali metal ions, alkaline-earth metal ions, and combinations thereof. Useful metal ions include, for example, ions derived from Ba, Li, Na, K, Cs, Mg, Ca, Sr, and combinations thereof. The conjugate base oxides are derived from acids selected, for example, from the group consisting of H₃PO₄, H₂TiO₃, HMnO₄, HTaO₃, HNbO₃, H₂ZrO₃, HOsO₄, HReO₄, and combinations thereof. In one variation of the invention, component having metal ions bonded to a conjugate base oxide of an inorganic acid is present in an amount from about 0.3 weight percent to about 50 weight percent of the total weight of the exhaust catalyst composition. As used herein these amounts are weight percentages of the amount of material applied to a substrate as a coating and therefore the weight percentages of the components in such coatings. In one variation of the invention, component having metal ions bonded to a conjugate base oxide of an inorganic acid is present in an amount from about 1 weight percent to about 20 weight percent of the total weight of the exhaust catalyst composition.

In most catalyst applications, a catalyst is made by forming a slurry from powder of the constituent components (metal oxide, precious metal salt) in a suitable solvent (e.g., water). The slurry is then washcoated onto a substrate such as the interior channels of a honeycombed-shaped brick. The coated brick is then dried and calcined at high temperature (>500° C.). Accordingly, in order to be easily incorporated into a catalyst the conjugate base oxides are milled or ground into fine particles suitable for washcoating on substrates. Alternatively, the conjugate base oxide may be provided as nanoparticles to allow facile incorporation into catalyst compositions.

In an important variation of this embodiment, the automotive exhaust catalyst composition further comprises a catalyst support. Such supports provide a mechanism for holding and dispersing the active components of the catalyst composition and provide increase surface areas for adsorption of the species to be altered by the action of the catalyst. Suitable supports include, for example, Al₂O₃, SiO₂, TiO₂, zeolites, and combinations thereof. In other variations, molecular sieves or sol-gel process derived supports are used as supports. Typically, such supports will also be provided as powders and mixed in with the other components to form a slurry to be applied by washcoating.

In another important variation of this embodiment, the metal or metal-containing compound comprises a precious metal. Suitable precious metals include those from the group of metals known as the platinum group (Ru, Rh, Pd, Os, Ir, Pt), especially platinum, palladium, and rhodium.

In another variation of this embodiment, the automotive exhaust catalyst composition includes a combination of a cerium-containing oxide and another metal compound selected from the group consisting of alkali metal containing compounds, alkaline-earth metal containing compounds, and combinations thereof. Suitable cerium-containing oxides include mixed oxides selected from the group consisting of Ce/Zr oxide, Ce/Pr oxide, Ce/Pr/Zr oxide, and combinations thereof.

In another embodiment of the invention a NOx trap that uses the automobile exhaust catalyst composition of the invention is provided. The NOx trap of the invention includes a substrate and a catalyst composition coated upon the substrate. The catalyst composition of this embodiment is the same as the automobile exhaust catalyst composition set forth above with the metal or metal-containing compound (that the metal or metal containing compound will alter the amount of a chemical component in the automobile exhaust) comprising a precious metal. Accordingly, the catalyst composition comprises a precious metal or precious metal-containing compound and a component having metal ions bonded to a conjugate base of an inorganic acid. As set forth above, the inorganic acid for which the base oxide is conjugate has a Ka such that the automotive catalyst composition resists phase transitions that reduce surface area. The Ka requirements, the examples of suitable conjugate base oxides, alkali metals, alkaline-earth metals, and precious metals (and all other details) are the same as those set forth above.

In yet another embodiment of the invention, a method of inhibiting coarsening in a catalyst composition. The method of the invention advantageously utilizes the compositions set forth above to form catalysts that resist coarsening. The method of the invention comprises combining a metal or metal-containing compound with a component having alkali or alkaline-earth metal ions bonded to a conjugate base oxide of an inorganic acid. The inorganic acid for which the base oxide is conjugate has a Ka such that the automotive catalyst composition resists phase transitions that reduce surface area. The Ka requirements, the examples of suitable conjugate base oxides, alkali metals, alkaline-earth metals, and precious metals (and all other details) are the same as those set forth above.

The following examples illustrate the various embodiments of the present invention. Those skilled in the art will recognize many variations that are within the spirit of the present invention and scope of the claims.

A. Formation of BaCO₃ Particles or Grains in Catalyst Formulations.

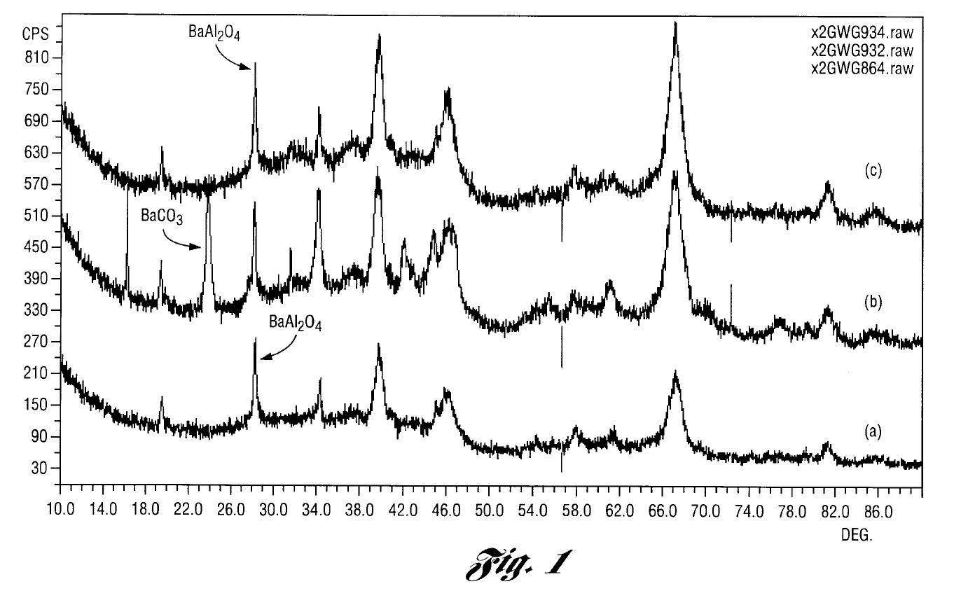

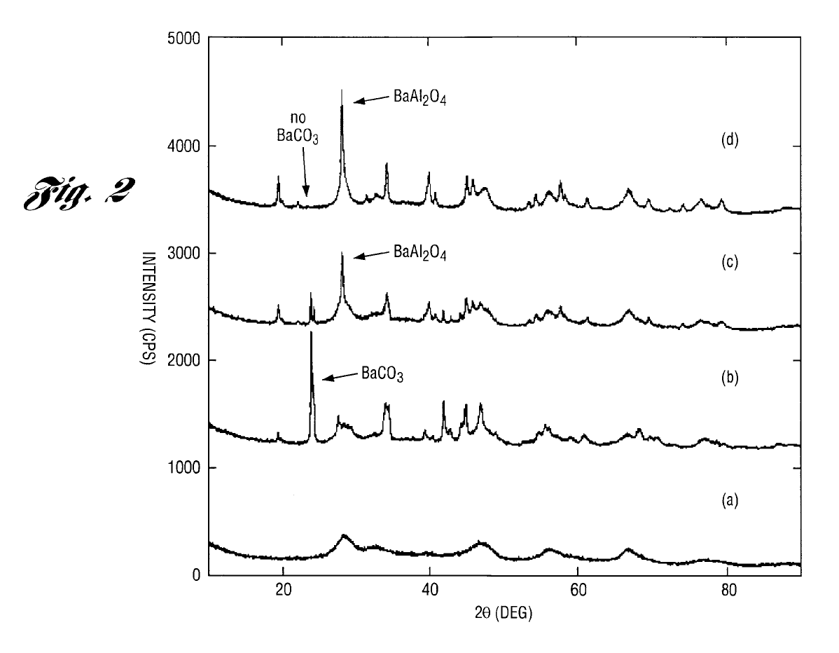

With reference to FIG. 1, the X-ray Powder Diffraction (XRD) patterns for a sample of Pt/BaO/Al₂O₃ that is typically employed in an LNT catalyst are provided. FIG. 1 shows only the presence of BaAl₂O without any BaCO₃ peaks observed after aging at 800° C. FIG. 1 also provides XRD patterns after the same composition has been exposed to ambient air for about 6 months. The formation of BaCO₃ is evident in FIG. 1 after such an exposure. FIG. 1 also provides the XRD pattern for a composition in which BaCO₃ has been transformed into BaAl₂O₄ by heating in H at 500° C. It has been also found that BaAl₂O₄ can be readily transformed into BaCO₃ after wetting a sample of Pt/BaO/Al₂O₃ originally exhibiting BaAl₂O₄XRD peaks only. This phenomenon was also observed on BaO/Al₂O₃ alone. The results indicate that Ba originally bound to Al₂O₃ as BaAl₂O₄ can be transformed into BaCO₃ crystallites in the presence of water and CO₂. Similarly, a sample of ceria-doped barium hexaaluminate nanoparticles with no crystalline Ba-containing species detectable by XRD (FIG. 2a) developed prominent BaCO₃ peaks when contacted with water (FIG. 2b). The crystallites of BaCO₃ can be eliminated by reduction in H₂ at T>500° C. (FIG. 1c) or can be converted to BaAl₂O₄ at T>750° C. as shown in FIG. 2c. The appearance of sharp BaCO₃XRD peaks indicates the growth of large BaCO₃ crystallites upon exposure to water and CO₂. Accordingly, the transformation between BaAl₂O₄ and BaCO₃ may result in coarsening of Ba-containing particles. Such coarsening can decrease the availability of Ba sites for adsorption and for interaction with precious metals. Since the exhaust from internal combustion engines contains water and CO₂, the conditions for the formation of BaCO₃ as well as BaAl₂O₄ at high exhaust temperatures are present.

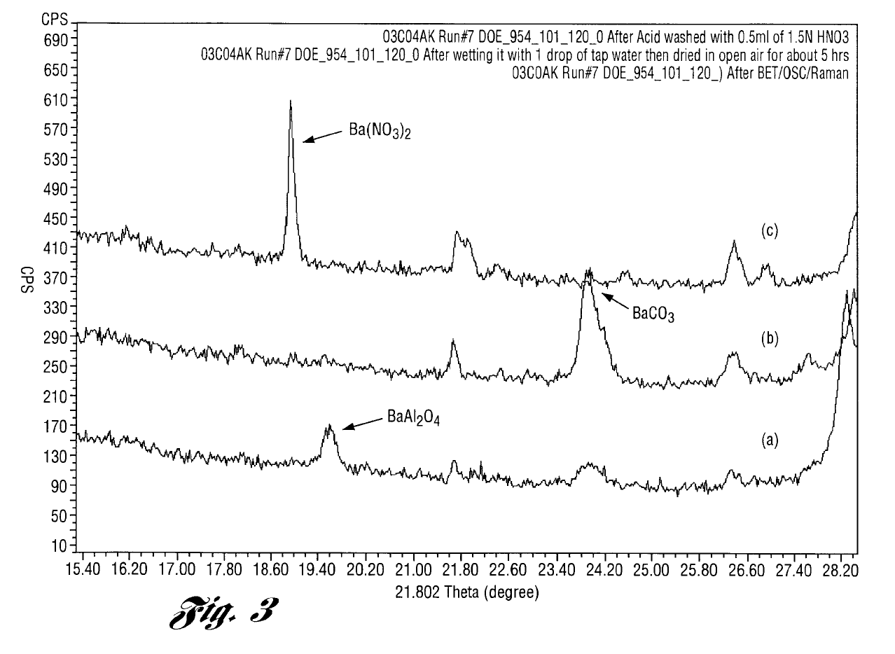

The transformations mentioned above for model catalysts of Pt/BaO/Al₂O₃ were also observed on commercial automotive catalysts. A commercial catalyst containing Ba was aged in simulated engine exhaust containing no phosphorus and was subject to XRD measurements. FIG. 3 shows that the XRD peaks of BaAl₂O₄ present right after aging (FIG. 3a) disappear and BaCO₃ peaks (FIG. 3b) appear after wetting the catalyst with water. After subsequent wetting with 1N HNO₃ solution, BaCO₃ peaks disappear and Ba(NO₃)₂ (FIG. 3c) peaks emerge. The transformations follow the acidity argument as described above: Ba prefers to be associated with the conjugate base oxide of the stronger acid. For the same catalysts aged under the same conditions but with additional phosphorus in the exhaust, no BaAl₂O₄ was detected and no BaCO₃ was observed prior to and after exposure to water. Presumably all Ba was bound to phosphorus oxides because phosphorus-containing acids are more acidic than H₂CO₃. The results are further evidence supporting the proposed mechanisms for the transformation of Ba species based on acidity.

B. Preparation of Ba Supported on Phosphate-Modified Alumina.

The modification of alumina with phosphate was done by dissolving a known amount of phosphate-salt into a predetermined volume of distilled water, adding a weighed sample of gamma-alumina into the solution under constant agitation, drying the solid mixture at 70° C., and calcining the solid sample at 600° C. for 6 hours. For example, to prepare a sample with 1.60 wt % P doped on alumina, Al_{2-1.60}P, 1) 0.3406 gram of (NH₄)₂ HPO₄ was dissolved in distilled water to form 9.150 ml solution, 2) 5.01 gram of high purity gamma-alumina was added into the solution with constant stirring, 3) the resulted mixture was dried at 70° C. overnight, and 4) the dried sample was calcined at 600° C. for 6 hours. Table 1 shows the samples of phosphate-modified alumina that were made with various weight percentages of phosphorus.

The prepared samples of phosphate-modified alumina were then impregnated with Ba-containing solutions, dried at 70° C., and calcined at 600° C. A sample of 5 wt % Ba supported on Al_{2-1.60}P (1.6 wt % P-modified alumina) was prepared by dissolving 0.1166 gram of Ba(CH₃COO)₂ to form a solution of 1.90 ml, adding 1.25 gram of Al₂₋₁₆₀P into the solution under constant stirring, drying the mixture at 70° C. overnight, and calcining the dried sample at 600° C. for 6 hours. The dried sample was also calcined at 750° C. for 6 hours without creating any significant difference. Two samples of Ba supported on phosphate-modified gamma-alumina are listed in Table 2 along with the samples for Ba supported on unmodified gamma-alumina as described below.

For comparison, Ba supported on unmodified gamma-alumina was prepared in the same way as described above for phosphate-doped alumina. For example, a sample of 5 wt % Ba supported on gamma-alumina was prepared by dissolving 0.1181 gram of Ba(CH₃COO)₂ to form 2.324 ml solution, adding 1.27 gram of gamma-alumina into the solution, drying the mixture at 70° C. overnight, and calcining the dried sample at 600° C. for 6 hours.

C. Preparation of Ba Supported on Phosphate-Incorporated Materials.

There are materials that have phosphorus oxides incorporated in the structures. If these materials possess high surface areas and are rather stable in the environments to be experienced, they can be used to stabilize Ba according to the mechanism disclosed in this invention. A commercial material, SAPO-11 (silica-alumina-phosphate-oxides molecular sieve) from UOP with 52 wt % P₂O₅, is one example. A sample of 10 wt % Ba on SAPO-11 was prepared by dissolving 0.3733 gram of Ba(CH₃COO)₂ to form 1.520 ml solution, adding 2.01 gram of SAPO-11 powder into the solution under constant stirring, drying the mixture at 70° C. overnight, and calcining the dried sample at 750° C. for 6 hours. Another support used is SAPO-34 from UOP with 47 wt % P 205. A sample of 5 wt % Ba supported on SAPO-34 was prepared by dissolving 0.1870 gram of Ba(CH₃COO)₂ to form 2.770 ml solution, adding 2.00 gram of SAPO-34 into the solution, drying the mixture at 70° C. overnight, and calcining the sample at 600° C. for 6 hours.

Alternatively, Ba can be added into a support by slowly evaporating water after mixing Ba-containing solution and the support. To prepare a sample with 5 wt % Ba, 0.4639 gram of Ba(CH₃COO)₂ was dissolved into 15.85 ml distilled water in a glass flask, 4.97 gram of SAPO-34 powder was added into the solution, the resulted mixture was heated at 80° C. under vigorous stirring with nitrogen gas flowing over the mixture to evaporate water. After the evaporation step for overnight, the sample was dried and then calcined at 600° C. for 6 hours. A similar sample with 5 wt % Ba supported on SAPO-34 was prepared in the same way using 0.4791 gram of Ba(NO₃)₂, 15.07 ml distilled water, and 5.05 gram of SAPO-34 powder.

D. Confirmation of Ba-Stabilization.

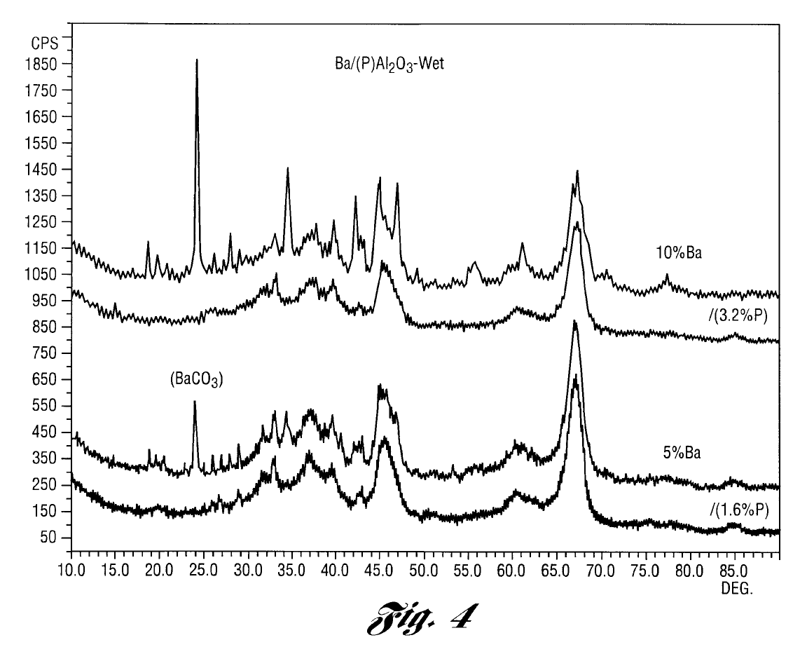

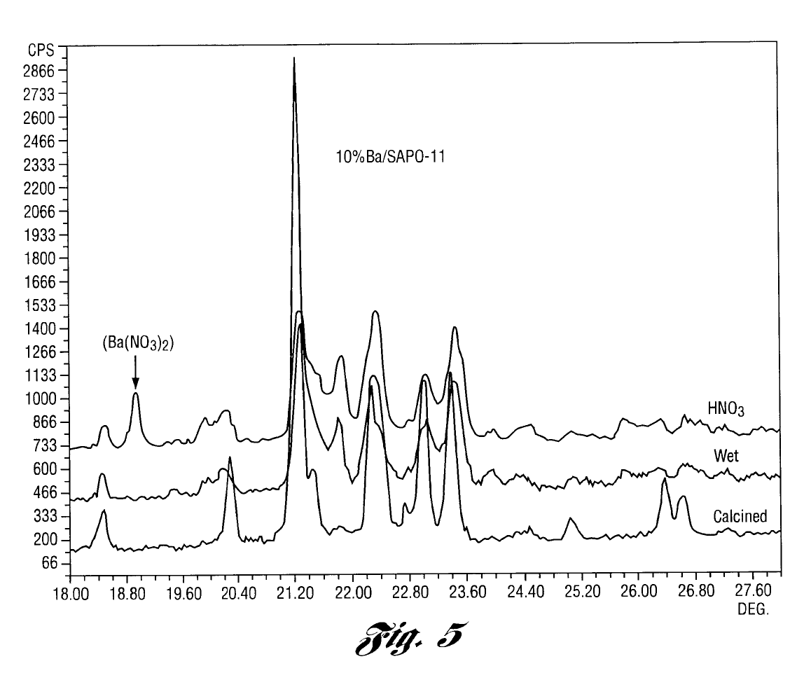

The stabilization of Ba on phosphate-modified alumina after exposure to water and CO₂ was confirmed using XRD (X-ray diffraction). A sample of 0.10 gram of 5 wt % Ba/(Al_{2-1.60}P) and a sample of 0.12 gram of 5 wt % Ba/Al₂O₃ were soaked in distilled water at room temperature in separate crucibles. The wetted samples were left to dry in ambient conditions overnight. The dried samples were subject to XRD examination. As shown in FIG. 4, distinct BaCO₃ peaks appeared in 5 wt % Ba/Al₂O₃, but no BaCO peaks or peaks from other Ba-containing species could be detected for 5 wt % Ba/(Al_{2-0.60}P). Similar observations were made upon XRD examination of samples of 10 wt % Ba/Al₂O₃ and 10 wt % Ba/(Al_{2-3.20}P), as also shown in FIG. 4. Further, as expected, there were no BaCO₃ XRD peaks found upon examination of 10 wt % Ba/SAPO-11 after 0.13 gram of sample was wetted with 0.500 ml distilled water and then dried in ambient conditions overnight as shown in FIG. 5.

After 0.10 gram of 5 wt % Ba/(A_{2-1.60}P) was wetted with 0.220 ml of 1N HNO₃ solution and then dried in ambient conditions overnight, there were Ba(NO₃)₂ XRD peaks found. A similar result was obtained upon XRD examination of 10 wt % Ba/SAPO-11, as shown in FIG. 5. This shows that the stabilization of Ba on phosphate-modified alumina does not exclude the formation of Ba nitrates that are the products of NOx adsorption. A summary of some examples of results of XRD examination are listed in Table 2 for the formation of BaCO₃ or Ba(NO₃)₂ on various materials.

E. Preparation of Catalysts Containing the Stabilized Ba Materials for NOx Adsorption.

The materials containing stabilized Ba in this invention (examples from Section B above) can be mixed with suitable amounts of solutions containing soluble platinum compounds. The amount of solution is sufficient enough to be adsorbed into the materials. The platinum compounds can be replaced with compounds of other metals such as rhodium or palladium. After mixing and ensuring the even distribution of solution into the stabilized Ba materials, the resulted samples can be dried at 70-120° C. and then calcined in air or reduced in H at 350° C.-600° C. The resulted catalysts of Pt/stabilized Ba-support can be made into slurry and applied to suitable substrates, preferably ceramic or metal honeycomb carriers. After this washcoating, the whole carriers can be calcined at 350-600° C. The materials can comprise from 5% to 40% by weight of the whole coated carriers. The catalysts can also be pressed into pellets with or without binders.

Alternatively, the materials containing stabilized Ba in this invention can be made into slurry and applied to suitable substrates, preferably ceramic or metallic honeycombs. After the coating, the whole substrates are then dried and calcined at 350-600° C. The Ba-containing materials can comprise about 5%-40% by weight of the whole carriers. The dried carriers are then impregnated with solutions of soluble platinum compounds. The impregnation can be done by dipping the carriers into the solutions and draining the solutions out of the honeycomb channels, or by forcing the solutions through the channels and wetting uniformly the washcoated materials. The platinum compounds can be replaced with other compounds of different metals including rhodium or palladium. The resulted carriers can be dried and then calcined or reduced at 350° C.-600° C.

The catalysts prepared above can be used for adsorption of NOx in gas streams. These catalysts have stabilized Ba against the formation of large BaCO₃ particles in the presence of H₂O and CO₂. They are most suitable for use in exhausts from combustion of fossil fuels. The catalysts made with honeycomb substrates can be used on vehicles by placing the catalysts in the exhaust system to remove NOx via adsorption, especially under lean conditions when there is not enough quantity of reductants to reduce NOx. The catalysts are most suitably for vehicles with lean-burn engines and used as lean-NOx-trap catalysts. The catalysts can adsorb NOx under lean operations of engines and release or reduce NOx under slightly rich operations. Since H₂O and CO₂ are always present in engine exhausts, the catalysts with stabilized Ba from this invention can eliminate the leaching of Ba from the catalysts and prevent the coarsening caused by the formation of large BaCO₃ particles.

TABLE 1
Parameters used in the preparation
of Phosphate-Modified Alumina

| | | weight of | weight of | volume of |
|---|---|---|---|---|
| Catalyst | | support | (NH₄)₂HPO₄ | solution |
| Name | wt % of P | (grams) | (grams) | (ml) |
| Al_{2-0.16}P | 0.16 | 5.01 | 0.03406 | 9.150 |
| Al_{2-0.32}P | 0.32 | 5.01 | 0.06813 | 9.150 |
| Al_{2-0.80}P | 0.80 | 5.01 | 0.1704 | 9.150 |
| Al_{2-1.60}P | 1.60 | 5.01 | 0.3406 | 9.150 |
| Al_{2-3.20}P | 3.20 | 5.02 | 0.6818 | 9.150 |

TABLE 2
XRD results for Ba-species peaks for Ba-containing Materials

| | After wetting | After soaking in |
|---|---|---|
| Catalyst | with H₂O in air | 1NHNO₃ solution |
| 5 wt % Ba/Al₂O₃ | observable | observable Ba(NO₃)₂ |
| | BaCO₃ peaks | peaks |
| 5 wt % Ba/(Al_{2-1.60}P) | no BaCO₃ or | observable Ba(NO₃)₂ |
| | other Ba-species | peaks |
| 10 wt % Ba/SAPO-11 | no BaCO₃ or | observable Ba(NO₃)₂ |
| | other Ba-species | peaks |
| 10 wt % Ba/(Al_{2-3.20}P) | no BaCO₃ or | observable Ba(NO₃)₂ |
| | other Ba-species | peaks |
| 10 wt % Ba/Al₂O₃ | sharp BaCO₃ peaks | not done |

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A coarsening resistant automotive exhaust catalyst composition comprising:
a metal or metal-containing compound that alters the amount of a chemical component in the automobile exhaust; and
a component having metal ions bonded to a conjugate base oxide of an inorganic acid, the inorganic acid having a Ka such that the automotive catalyst composition resists phase transitions that reduce surface area and the metal ions being selected from the group consisting of alkali metal ions, alkaline-earth metal ions, and combinations thereof.

2. The automotive exhaust catalyst composition of claim 1 wherein the Ka is from about 5.0×10⁻⁷ to about 1.0.

3. The automotive exhaust catalyst composition of claim 1 wherein the Ka is from about 5.0×10⁻⁵ to about 1.0×10⁻¹.

4. The automotive exhaust catalyst composition of claim 1 wherein the alkali or alkaline-earth containing compound includes an atom selected from the group consisting of Ba, Li, Na, K, Cs, Mg, Ca, Sr, and combinations thereof.

5. The automotive exhaust catalyst composition of claim 1 wherein the conjugate base oxide is the conjugate base of an acid selected from the group consisting of H₃PO₄, H₂TiO₃, HMnO₄, HTaO₃, HNbO₃, H₂ZrO₃, HOsO₄, HReO₄, and combinations thereof.

6. The automotive exhaust catalyst composition of claim 1 wherein the component having metal ions bonded to a conjugate base oxide of an inorganic acid is present in an amount from about 0.3 weight percent to about 50 weight percent of the total weight of the exhaust catalyst composition.

7. The automotive exhaust catalyst composition of claim 1 wherein the component having metal ions bonded to a conjugate base oxide of an inorganic acid is present in an amount from about 1 weight percent to about 20 weight percent of the total weight of the exhaust catalyst composition.

8. The automotive exhaust catalyst composition of claim 1 wherein the conjugated base oxides are milled or grounded into fine particles suitable for washcoating on substrates.

9. The automotive exhaust catalyst composition of claim 1 wherein the conjugate base oxide are nanoparticles.

10. The automotive exhaust catalyst composition of claim 1 further comprising a catalyst support.

11. The automotive exhaust catalyst composition of claim 1 wherein the conjugate base oxides are deposited onto or impregnated in the catalyst support.

12. The automotive exhaust catalyst composition of claim 10 wherein the catalyst support is selected from the group consisting of Al₂O₃, SiO₂, TiO₂, zeolites, and combinations thereof.

13. The automotive exhaust catalyst composition of claim 10 wherein the conjugated base oxides are SAPO molecular sieves or sol-gel process derived supports.

14. The automotive exhaust catalyst composition of claim 1 wherein the precious metal is selected from the group consisting of platinum, palladium, and rhodium.

15. The automotive exhaust catalyst composition of claim 14 wherein the precious metal is platinum.

16. The automotive exhaust catalyst composition of claim 1 further comprising a Ce-containing oxides.

17. The automotive exhaust catalyst composition of claim 16 wherein the Ce-containing oxide is a mixed oxide selected from the group consisting of Ce/Zr oxide, Ce/Pr oxide, Ce/Pr/Zr oxide, and combinations thereof.

18. A NOx trap comprising:
a substrate;
a catalyst composition coated upon the substrate, the catalyst composition comprising;
a precious metal-containing compound;
a component having barium metal ions bonded to a conjugate base oxide of an inorganic acid, the inorganic acid having a Ka such that the automotive catalyst composition resists phase transitions that reduce surface area.

19. The NOx trap of claim 18 wherein the Ka is from about 5.0×10⁻⁷ to about 1.

20. The NOx trap of claim 18 wherein the Ka is from about 5.0×10⁻⁵ to about 1.0×10⁻¹.

21. The NOx trap of claim 18 wherein the conjugate base oxides are derived from acids selected from the group consisting of H₃PO₄, H₂TiO₃, HMnO₄, HTaO₃, HNbO₃, H₂ZrO₃, HOsO₄, HReO₄, and combinations thereof.

22. The NOx trap of claim 18 wherein the catalyst composition further comprises a catalyst support.

23. The NOx trap claim 23 wherein the catalyst support is selected from the group consisting of Al₂O₃, SiO₂, TiO₂, zeolites, SAPO molecular sieves, sol-gel process derived supports, and combinations thereof.

24. A method of inhibiting coarsening in an automobile exhaust catalyst composition having an alkali or alkaline-earth metal containing compound, the method comprising:
combining a metal or metal-containing compound with a component having alkali or alkaline-earth metal ions bonded to a conjugate base oxide of an inorganic acid, the inorganic acid having a Ka such that the automotive catalyst composition resists phase transitions that reduce surface area.

25. The method of claim 24 wherein the Ka is from about 5.0×10⁻⁷ to about 1.

26. The method of claim 24 wherein the alkali or alkaline-earth metal ions are selected from the group consisting of ions from Ba, Li, Na, K, Cs, Mg, Ca, Sr, and combinations thereof.

27. The method of claim 24 wherein the conjugate base oxides are derived from acids selected from the group consisting of H₃PO₄, H₂TiO₃, HMnO₄, HTaO₃, HNbO₃, H₂ZrO₃, HOsO₄, HReO₄, and combinations thereof.
